(19) United States
(12) Patent Application Publication
(10) Pub. No.: US 2026/0323223 A1
(43) Pub. Date: Oct. 15, 2026

(54) SOUND GENERATING APPARATUS AND ELECTRONIC DEVICE

(71) Applicant: GOERTEK INC., Weifang (CN)

(72) Inventors: Xiaodong CAI, Weifang (CN); Ye TIAN, Weifang (CN)

(21) Appl. No.: 19/696,519

(22) Filed: Jun. 3, 2026

Related U.S. Application Data
(63) Continuation of application No. PCT/CN2025/103740, filed on Jun. 26, 2025.

(30) Foreign Application Priority Data
Jun. 28, 2024 (CN) 202410867864.7

(51) Int. Cl. H04R 9/06; H04R 1/02; H04R 7/04; H04R 9/02; H04R 9/04

(52) U.S. Cl. CPC H04R 9/063; H04R 1/025; H04R 7/04; H04R 9/025; H04R 9/046

(57) ABSTRACT

A sound generating apparatus and an electronic device. The sound generating apparatus includes a magnetic circuit system, first and second vibration systems, and a housing. The magnetic circuit system forms first and second magnetic gaps. The first vibration system includes a first annular diaphragm and a first voice coil, and the second vibration system includes a second diaphragm and a second voice coil. The first annular diaphragm is no higher than a top surface of the magnetic circuit system, so that the housing and the first vibration system define a first acoustic cavity. A side wall of the housing has a first side acoustic hole communicating with the first acoustic cavity. The housing and the second vibration system define a second acoustic cavity independent of the first acoustic cavity, and the side wall further has a second side acoustic hole communicating with the second acoustic cavity.

### CROSS-REFERENCE TO RELATED APPLICATIONS

This application is a continuation application of International Application No. PCT/CN2025/103740, filed on Jun. 26, 2025, which claims priority to Chinese Patent Application No. 202410867864.7, filed on Jun. 28, 2024. The disclosures of the above-mentioned applications are incorporated herein by reference in their entireties.

### TECHNICAL FIELD

The present application relates to the technical field of sound energy conversion, and in particular to a sound generating apparatus and an electronic device.

### BACKGROUND

In recent years, with rapid development in the field of smart terminal electronics, various electronic devices, such as mobile phones, earphones, and tablet computers, have gradually shown new trends toward miniaturization, reduced thickness, and intelligence. Consumers have increasingly high requirements for speakers in electronic devices, and miniaturized, high-performance, high-sound-quality speakers have gradually become a mainstream demand.

At present, following the development direction of speaker miniaturization and high performance, conventional double-sided speakers can no longer continue to improve performance to meet consumer demand by increasing outer dimensions, and the miniaturization trend of electronic devices further compresses the space available for internal speakers, making existing speakers difficult to install smoothly because of their relatively large size.

### SUMMARY

The present application provides a sound generating apparatus and an electronic device to further reduce a size of a speaker.

To achieve the above objective, a sound generating apparatus provided by the present application includes:
a magnetic circuit system, the magnetic circuit system including a magnet assembly, the magnet assembly including a central magnetic circuit and a side magnet surrounding the central magnetic circuit, the central magnetic circuit and the side magnet forming a first magnetic gap, and the central magnetic circuit forming a second magnetic gap;
a first vibration system, the first vibration system including a first annular diaphragm and a first voice coil connected to each other, and the first voice coil being provided corresponding to the first magnetic gap;
a second vibration system, the second vibration system including a second diaphragm and a second voice coil connected to each other, the second voice coil being provided corresponding to the second magnetic gap, and the first vibration system and the second vibration system being respectively provided on two sides of the magnetic circuit system along a vibration direction; and
a housing configured to accommodate the magnetic circuit system, the first vibration system, and the second vibration system, a height of the first annular diaphragm being not greater than a height of a top surface of the magnetic circuit system, so that the housing and the first vibration system define a first acoustic cavity, a side wall of the housing is provided with a first side acoustic hole communicating with the first acoustic cavity, the housing and the second vibration system further define a second acoustic cavity independent of the first acoustic cavity, and the side wall of the housing is further provided with a second side acoustic hole communicating with the second acoustic cavity.

In an embodiment, the top surface of the central magnetic circuit is provided with a first protrusion, the first protrusion abuts against the housing, the first annular diaphragm is provided around the first protrusion, and a height of a top surface of the first annular diaphragm is not greater than a height of a top surface of the first protrusion.

In an embodiment, the housing includes a housing body and a first metal sheet connected to each other. The housing body and the first metal sheet define an accommodating cavity capable of accommodating the magnetic circuit system, the first vibration system, and the second vibration system. The top surface of the central magnetic circuit passes through an inner hole of the first annular diaphragm and abuts against the first metal sheet. A side wall of the housing body is provided with the first side acoustic hole and the second side acoustic hole.

In an embodiment, the second diaphragm includes a second annular diaphragm;
the housing is provided with a second protrusion on a side facing th second annular diaphragm, the second protrusion abuts against a bottom surface of the central magnetic circuit, and the second annular diaphragm is provided around the second protrusion; or,
the bottom surface of the central magnetic circuit is provided with a second protrusion, the second protrusion abuts against the housing, and the second annular diaphragm is provided around the second protrusion.

In an embodiment, the housing includes a housing body and a second metal sheet connected to each other. The second metal sheet protrudes on a side facing the second annular diaphragm to form the second protrusion. The second protrusion passes through an inner hole of the second annular diaphragm and abuts against the bottom surface of the central magnetic circuit. A side wall of the housing is provided with the first side acoustic hole and the second side acoustic hole.

In an embodiment, an outer edge of the top surface of the magnetic circuit system is provided with a first mounting groove, and an inner peripheral edge of a side of the first annular diaphragm facing the second vibration system is connected to a bottom wall of the first mounting groove.

In an embodiment, the sound generating apparatus includes a first working state and a second working state. In the first working state, the first vibration system and the second vibration system radiate sound waves of a same phase outward. In the second working state, the first vibration system and the second vibration system radiate sound waves of opposite phases outward.

In an embodiment, the first annular diaphragm is sequentially provided with a first inner folded ring and a first outer folded ring from inside to outside, the first vibration system includes a first dome, the first dome is connected to the first annular diaphragm and is located between the first inner folded ring and the first outer folded ring, and the first voice coil is fixed to the first dome;
the second diaphragm is sequentially provided with a second inner folded ring and a second outer folded ring from inside to outside, the second vibration system includes a second dome, the second dome is connected to the second diaphragm and is located between the second inner folded ring and the second outer folded ring, and the second voice coil is fixed to the second dome.

In an embodiment, the first inner folded ring protrudes in a direction distant from the second diaphragm, the first outer folded ring protrudes in a direction toward the second diaphragm, the second inner folded ring protrudes in a direction distant from the first annular diaphragm, and the second outer folded ring protrudes in a direction toward the first annular diaphragm.

In an embodiment, the central magnetic circuit includes a central magnet, a secondary central magnet, and a first auxiliary magnet. The secondary central magnet surrounds an outer periphery of the central magnet and is spaced apart from the central magnet to form the second magnetic gap. The side magnet surrounds an outer periphery of the secondary central magnet and is spaced apart from the secondary central magnet to form the first magnetic gap. An inner peripheral edge of the first annular diaphragm facing the second diaphragm is connected to the first auxiliary magnet.

In an embodiment, the magnetic circuit system further includes a magnetic conductive plate assembly. The magnetic conductive plate assembly includes a first magnetic conductive plate and a second magnetic conductive plate. Sides of the central magnet and the secondary central magnet distant from the first annular diaphragm are connected to the first magnetic conductive plate, another side of the first magnetic conductive plate is connected to the first auxiliary magnet, and sides of the secondary central magnet and the side magnet facing the first annular diaphragm are connected to the second magnetic conductive plate.

In an embodiment, the magnetic circuit system further includes a magnetic conductive plate assembly. The magnetic conductive plate assembly includes a first magnetic conductive plate and a second magnetic conductive plate. Sides of the central magnet and the secondary central magnet distant from the first annular diaphragm are connected to the first magnetic conductive plate, another side of the first magnetic conductive plate is connected to the first auxiliary magnet, and sides of the secondary central magnet and the side magnet facing the first annular diaphragm are connected to the second magnetic conductive plate.

In an embodiment, the magnetic conductive plate assembly further includes a third magnetic conductive plate and a side magnetic conductive plate. The third magnetic conductive plate is sandwiched between the second auxiliary magnet and the central magnet, and the side magnet is connected to the side magnetic conductive plate on a side adjacent to the first annular diaphragm.

In an embodiment, a dimension of the second auxiliary magnet in a horizontal plane along at least one of a first direction and a second direction is less than a dimension of the central magnet in a corresponding direction.

In an embodiment, a dimension of the first auxiliary magnet extending in a horizontal plane along the first direction is greater than a dimension of the central magnet extending along the first direction, and a dimension of the first auxiliary magnet extending in the horizontal plane along the second direction is greater than a dimension of the central magnet extending along the second direction.

In an embodiment, the sound generating apparatus further includes an isolation member provided with a plurality of vent holes, and the isolation member surrounds an outer periphery of the side magnet and is connected to the side magnet.

In an embodiment, the first annular diaphragm is provided with a first conductive layer, and the first conductive layer is electrically connected to the first voice coil and a solder pad; and/or,
the second diaphragm is provided with a second conductive layer, and the second conductive layer is electrically connected to the second voice coil and a solder pad.

In an embodiment, the first magnetic gap and the second magnetic gap are spaced apart in a horizontal direction.

The present application further provides an electronic device including a device housing and the sound generating apparatus described above.

According to the technical solution of the present application, the housing is used to implement double-sided sound output, so that the overall thickness of the sound generating apparatus can be reduced and the sound generating apparatus is suitable for use scenarios with smaller installation spaces. Taking an ultra-thin mobile phone as an example, the installation space for the sound generating apparatus is limited, and therefore the double-sided sound generating apparatus can better meet the use requirements of this scenario.

### BRIEF DESCRIPTION OF THE DRAWINGS

In order to more clearly illustrate the technical solutions in the embodiments of the present application or in the related art, the drawings required for the description of the embodiments or the related art are briefly introduced below. It is apparent that the drawings in the following description merely show some embodiments of the present application. For those of ordinary skill in the art, other drawings can also be obtained based on the structures shown in these drawings without creative efforts.

FIG. 1 is a schematic structural diagram of a sound generating apparatus provided with a housing according to an embodiment of the present application.

FIG. 2 is a schematic structural diagram of the sound generating apparatus in FIG. 1 from another perspective.

FIG. 3 is an exploded schematic structural diagram of a sound generating apparatus provided with a housing according to an embodiment of the present application.

FIG. 4 is a schematic cross-sectional diagram of a sound generating apparatus provided with a housing according to an embodiment of the present application.

FIG. 5 is a schematic cross-sectional diagram of a sound generating apparatus provided with a housing according to another embodiment of the present application.

FIG. 6 is a schematic structural diagram of a sound generating apparatus with the housing removed according to an embodiment of the present application.

FIG. 7 is a schematic structural diagram of the sound generating apparatus in FIG. 6 from another perspective.

FIG. 8 is a schematic structural diagram of a first annular diaphragm according to an embodiment of the present application.

FIG. 9 is a schematic structural diagram of a second annular diaphragm according to an embodiment of the present application.

FIG. 10 is a schematic structural diagram illustrating connection between a second auxiliary magnet and a second annular diaphragm according to an embodiment of the present application.

The implementation of the objectives, functional features, and advantages of the present application will be further described with reference to the embodiments and the accompanying drawings.

### DETAILED DESCRIPTION OF THE EMBODIMENTS

The technical solutions in the embodiments of the present application are clearly and completely described below with reference to the accompanying drawings. It is apparent that the described embodiments are only some, rather than all, embodiments of the present application. All other embodiments obtained by those of ordinary skill in the art based on the embodiments of the present application without creative efforts fall within the protection scope of the present application.

It should be noted that, if directional indications, such as up, down, left, right, front, and rear, are involved in the embodiments of the present application, the directional indications are merely used to explain relative positional relationships, movement conditions, and the like between components in a specific posture. If the specific posture changes, the directional indications also change accordingly.

In addition, if descriptions such as “first” and “second” are involved in the embodiments of the present application, the descriptions of “first”, “second” and the like are merely for descriptive purposes and should not be understood as indicating or implying relative importance or implicitly indicating the number of indicated technical features. Thus, a feature defined with “first” or “second” may explicitly or implicitly include at least one such feature. In addition, if “and/or” appears throughout the text, the meaning includes three parallel solutions. For example, “A and/or B” includes solution A, solution B, or a solution in which both A and B are satisfied. In addition, the technical solutions of the embodiments may be combined with each other, provided that such combinations can be implemented by those of ordinary skill in the art. When a combination of technical solutions is contradictory or cannot be implemented, the combination should be considered nonexistent and outside the protection scope claimed by the present application.

In recent years, with rapid development in the field of smart terminal electronics, various electronic devices, such as mobile phones, earphones, and tablet computers, have gradually shown new trends toward miniaturization, reduced thickness, and intelligence. Consumers have increasingly high requirements for speakers in electronic devices, and miniaturized, high-performance, high-sound-quality speakers have gradually become a mainstream demand. At present, following the development direction of speaker miniaturization and high performance, conventional double-sided speakers can no longer continue to improve performance to meet consumer demand by increasing outer dimensions, and the miniaturization trend of electronic devices further compresses the space available for internal speakers, making existing speakers difficult to install smoothly because of their relatively large size.

Thus, the present application provides a sound generating apparatus.

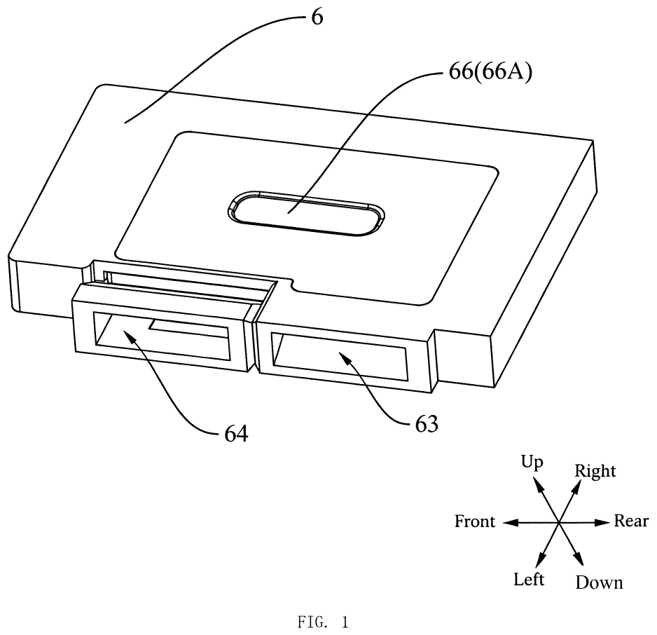

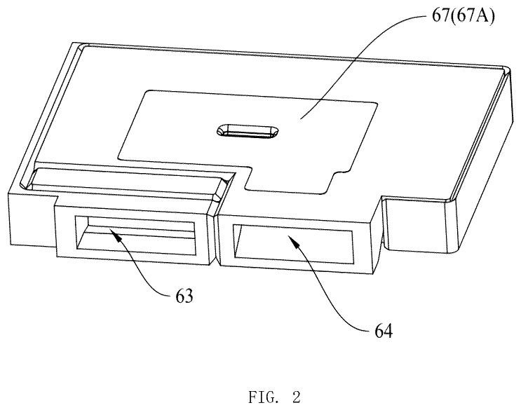

Referring to FIG. 1 to FIG. 4, in an embodiment of the present application, the sound generating apparatus 100 includes a magnetic circuit system 1, a first vibration system 2, a second vibration system 3, and a housing 6. The magnetic circuit system 1 includes a magnet assembly 11. The magnet assembly 11 includes a central magnetic circuit and a side magnet 113 surrounding the central magnetic circuit. The central magnetic circuit and the side magnet 113 form a first magnetic gap 116, and the central magnetic circuit has a second magnetic gap 117. The first vibration system 2 includes a first annular diaphragm 21 and a first voice coil 22 connected to each other. The first voice coil 22 corresponds to the first magnetic gap 116, that is, the first voice coil 22 is at least partially inserted into the first magnetic gap 116. The second vibration system 3 includes a second diaphragm 31A and a second voice coil 32 connected to each other. The second voice coil 32 corresponds to the second magnetic gap 117, that is, the second voice coil 32 is at least partially inserted into the second magnetic gap 117. The first vibration system 2 and the second vibration system 3 are respectively provided on two sides of the magnetic circuit system 1 along a vibration direction. The housing 6 can accommodate the magnetic circuit system 1, the first vibration system 2, and the second vibration system 3. A height of the first annular diaphragm 21 is not greater than a height of a top surface of the magnetic circuit system 1, such that the housing 6 and the first vibration system 2 define a first acoustic cavity 61. A side wall of the housing 6 is provided with a first side acoustic hole 63 communicating with the first acoustic cavity 61. The housing 6 and the second vibration system 3 further define a second acoustic cavity 62 independent of the first acoustic cavity 61. The side wall of the housing 6 is further provided with a second side acoustic hole 64 communicating with the second acoustic cavity 62. In the present application, the first side acoustic hole 63 and the second side acoustic hole 64 may be located on the same side wall of the sound generating apparatus 100, or may be respectively located on different side walls of the sound generating apparatus 100.

According to the technical solution of the present application, the housing 6 is used to implement double-sided sound output. The sound generating apparatus 100 can satisfy double-sided sound output scenarios and can adapt to an ultra-thin whole-machine structure having only side sound output ducts. Compared with a structure of the sound generating apparatus 100 that provides front sound output plus side sound output, the front cover component is omitted, so that overall thickness is reduced. Further, because double-sided sound output is used, the acoustic cavities and acoustic holes can extend horizontally, reducing thickness compared with acoustic cavities and acoustic holes extending vertically. Taking a mobile phone as an example, the installation space for the sound generating apparatus 100 in an ultra-thin mobile phone is limited, and therefore the double-sided sound generating apparatus 100 can better meet the use requirements of this scenario.

In an embodiment, the top surface of the central magnetic circuit is provided with a first protrusion 1142. The first protrusion 1142 abuts against the housing 6. The first annular diaphragm 21 is provided around the first protrusion 1142. A height of a top surface of the first annular diaphragm 21 is not greater than a height of a top surface of the first protrusion 1142. An inner wall of the housing 6 abuts against the top surface of the first protrusion 1142, and the inner wall of the housing 6 is further connected to a side wall of the magnetic circuit system 1, thereby improving stability of the magnetic circuit system 1. The height of the top surface of the first annular diaphragm 21 is not greater than the height of the top surface of the first protrusion 1142, which ensures that the first annular diaphragm 21 has a vibration space, so that the housing 6 and the first vibration system 2 define the first acoustic cavity 61. In addition, compared with a diaphragm located on the top of the central magnetic circuit, the first annular diaphragm 21 is lower in height, so that the sound generating apparatus 100 can be made thinner, that is, a dimension of the sound generating apparatus 100 in an up-down direction is reduced. The up-down direction is the up-down direction shown in FIG. 1. It should be noted that providing the first protrusion 1142 increases the volume of the central magnetic circuit and improves performance of the sound generating apparatus 100.

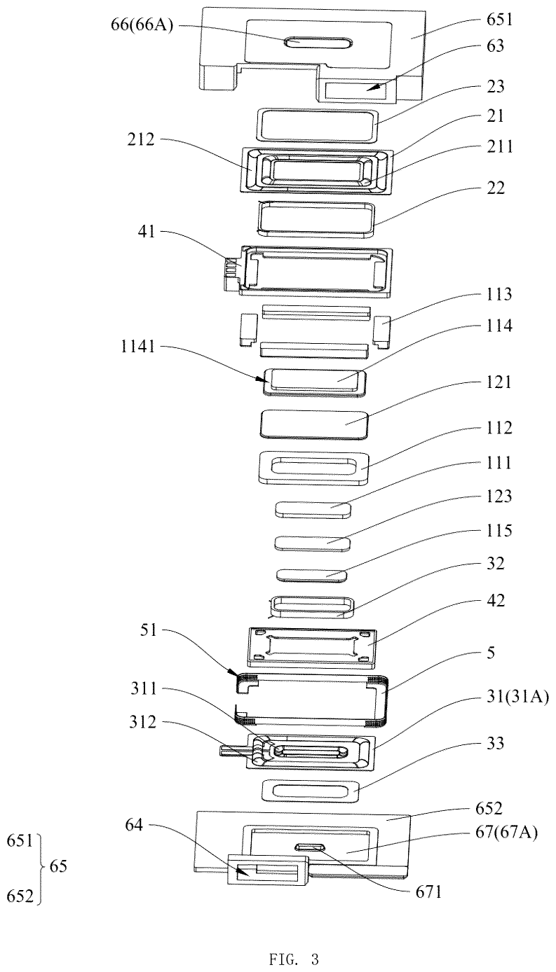

Referring to FIG. 3 to FIG. 5, in an embodiment, the housing 6 includes a housing body 65 and a first metal sheet 66 connected to each other. The housing body 65 and the first metal sheet 66 define an accommodating cavity capable of accommodating the magnetic circuit system 1, the first vibration system 2, and the second vibration system 3. The top surface of the central magnetic circuit passes through an inner hole of the first annular diaphragm 21 and abuts against the first metal sheet 66. A side wall of the housing body 65 is provided with the first side acoustic hole 63 and the second side acoustic hole 64. The first metal sheet 66 may be a first steel sheet 66A. The first metal sheet 66 abuts against the top surface of the central magnetic circuit, thereby improving stability of the magnetic circuit system 1.

According to an embodiment of the present application, the housing body 65 is provided with a first mounting hole for accommodating the first metal sheet 66, the first metal sheet 66 is embedded in the housing body 65, the first metal sheet 66 is injection-molded to the housing body 65, or the first metal sheet 66 and the housing body 65 are integrally formed. Compared with directly arranging the first metal sheet 66 on a surface of the housing body 65, the wall thickness of the housing 6 can be reduced, so that the sound generating apparatus 100 can be made thinner.

In an embodiment, the second diaphragm 31A includes a second annular diaphragm 31. The housing 6 is provided with a second protrusion 671 on a side facing the second annular diaphragm 31. The second protrusion 671 abuts against a bottom surface of the central magnetic circuit, and the second annular diaphragm 31 is provided around the second protrusion 671. Alternatively, the bottom surface of the central magnetic circuit is provided with a second protrusion 671, the second protrusion 671 abuts against the housing 6, and the second annular diaphragm 31 is provided around the second protrusion 671. The inner wall of the housing 6 abuts against the bottom surface of the central magnetic circuit, and the inner wall of the housing 6 is further connected to a side wall of the magnetic circuit system 1, thereby improving stability of the magnetic circuit system 1.

In an embodiment, the housing 6 includes a housing body 65 and a second metal sheet 67 connected to each other. The second metal sheet 67 protrudes on a side facing the second annular diaphragm 31 to form the second protrusion 671. The second protrusion 671 passes through an inner hole of the second annular diaphragm 31 and abuts against the bottom surface of the central magnetic circuit. A side wall of the housing is provided with the first side acoustic hole 63 and the second side acoustic hole 64. The second metal sheet 67 may also be a second steel sheet 67A. The second metal sheet 67 abuts against the bottom surface of the central magnetic circuit, thereby improving stability of the magnetic circuit system 1.

In an embodiment, the second metal sheet 67 protrudes on the side facing the second annular diaphragm 31 to form the second protrusion 671, and the second protrusion 671 abuts against a bottom surface of the magnetic circuit system 1. The second metal sheet 67 protrudes upward and abuts against the bottom surface of the magnetic circuit system 1, thereby improving stability of the magnetic circuit system 1 while avoiding interference with the second annular diaphragm 31. It should be noted that a side of the second annular diaphragm 31 distant from the first annular diaphragm 21 is spaced apart from the inner wall of the housing 6.

According to an embodiment of the present application, the housing 6 includes a first housing 651 and a second housing 652 that are detachably connected. The first housing 651 is provided with a first steel sheet 66A and is provided with the first side acoustic hole 63. The second housing 652 is provided with a second steel sheet 67A and is provided with the second side acoustic hole 64. The first housing 651 and the second housing 652 define an accommodating cavity capable of accommodating the magnetic circuit system 1, the first vibration system 2, and the second vibration system 3.

Referring to FIG. 3, in an embodiment, an outer edge of the top surface of the magnetic circuit system 1 is provided with a first mounting groove 1141, and an inner peripheral edge of a side of the first annular diaphragm 21 facing the second vibration system 3 is connected to a bottom wall of the first mounting groove 1141. By providing the first mounting groove 1141, a portion of the first auxiliary magnet 114 can protrude through an inner ring of the first annular diaphragm 21, thereby effectively increasing the volume of the first auxiliary magnet 114 and improving performance of the sound generating apparatus 100. In addition, providing the first mounting groove 1141 can provide clearance for the vibration space of the first annular diaphragm 21 and reduce the probability of interference between the first annular diaphragm 21 and the first auxiliary magnet 114. Further, by providing the first mounting groove 1141, the inner peripheral edge of the first annular diaphragm 21 is sealingly connected to the bottom wall of the first mounting groove 1141, thereby providing a certain waterproof effect. The first annular diaphragm 21 used in combination with the first mounting groove 1141 also effectively reduces the height of the first annular diaphragm 21. Compared with a case in which the first annular diaphragm 21 covers the top surface of the magnetic circuit system 1, the sound generating apparatus 100 can be made thinner. It should be noted that, by adding the first auxiliary magnet 114, the sound generating apparatus 100 has better performance at the same volume and has a smaller volume at the same performance compared with a conventional double-sided sound generating apparatus. It should also be noted that the top surface of the first auxiliary magnet 114 is provided with the first protrusion 1142.

In an embodiment, the sound generating apparatus 100 includes a first working state and a second working state. In the first working state, the first vibration system 2 and the second vibration system 3 radiate sound waves of a same phase outward. In the second working state, the first vibration system 2 and the second vibration system 3 radiate sound waves of opposite phases outward. In the first working state, the first vibration system 2 and the second vibration system 3 radiate sound waves of the same phase outward, thereby improving sound quality of the sound generating apparatus 100. In the second working state, the first vibration system 2 and the second vibration system 3 radiate sound waves of opposite phases outward, so that the sound generating apparatus 100 can be applied to an electronic device requiring call privacy and can achieve a better low-leakage effect.

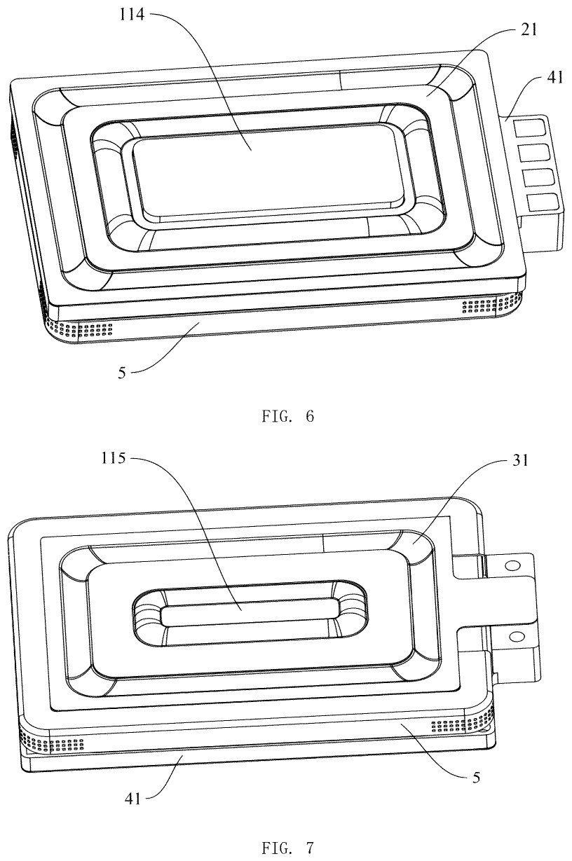

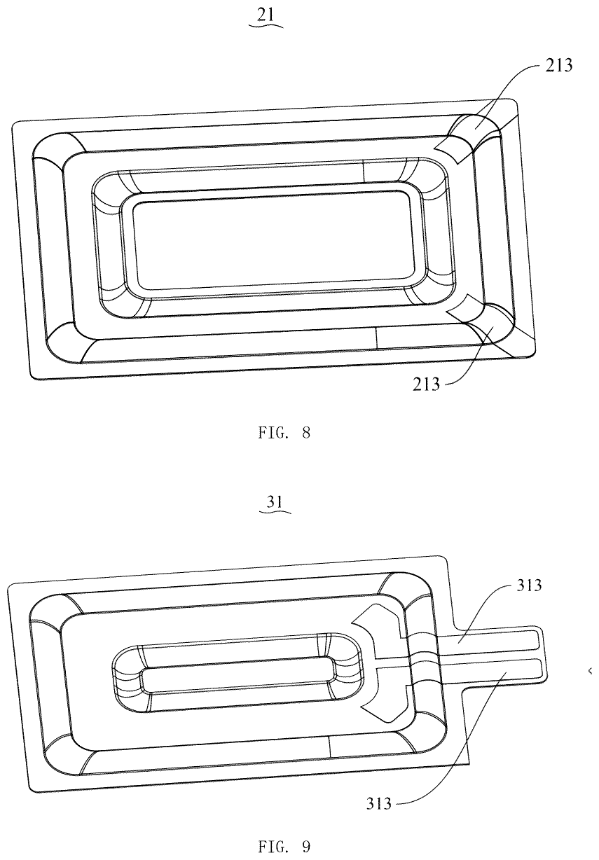

Referring to FIG. 4 to FIG. 7, in an embodiment, the first annular diaphragm 21 is sequentially provided with a first inner folded ring 211 and a first outer folded ring 212 from inside to outside. The first vibration system 2 includes a first dome 23. The first dome 23 is connected to the first annular diaphragm 21 and is located between the first inner folded ring 211 and the first outer folded ring 212, and the first voice coil 22 is fixed to the first dome 23. The second annular diaphragm 31 is sequentially provided with a second inner folded ring 311 and a second outer folded ring 312 from inside to outside. The second vibration system 3 includes a second dome 33. The second dome 33 is connected to the second annular diaphragm 31 and is located between the second inner folded ring 311 and the second outer folded ring 312, and the second voice coil 32 is fixed to the second dome 33. Taking the first dome 23 as an example, the first dome 23 is bonded to a flat region between the first inner folded ring 211 and the first outer folded ring 212. The first dome 23 may be located on an upper side of the first annular diaphragm 21 or on a lower side of the first annular diaphragm 21. When the first dome 23 is located on the upper side of the first annular diaphragm 21, one side of the first annular diaphragm 21 is connected to the first voice coil 22, and another side of the first annular diaphragm 21 is connected to the first dome 23, thereby fixing the first voice coil 22 to the first dome 23. When the first dome 23 is located on the lower side of the first annular diaphragm 21, one side of the first dome 23 is connected to the first annular diaphragm 21, and another side of the first dome 23 is connected to the first voice coil 22, thereby ensuring that the first voice coil 22 is within a radiation range of the first dome 23. The second dome 33 is configured similarly to the first dome 23, and details are not repeated here.

In an embodiment, the first inner folded ring 211 protrudes in a direction distant from the second annular diaphragm 31, and the first outer folded ring 212 protrudes in a direction toward the second annular diaphragm 31. The second inner folded ring 311 protrudes in a direction distant from the first annular diaphragm 21, and the second outer folded ring 312 protrudes in a direction toward the first annular diaphragm 21. At present, a conventional diaphragm generally has only one annular protrusion at an outer periphery. In this embodiment, taking the first annular diaphragm 21 as an example, the first annular diaphragm 21 has the first inner folded ring 211 and the first outer folded ring 212. The first inner folded ring 211 is arranged adjacent to the first auxiliary magnet 114 and protrudes upward, which not only reduces the probability of collision between the first auxiliary magnet 114 and the first annular diaphragm 21, but also reserves a space between the first annular diaphragm 21 and the central magnet 111 for accommodating more magnets because the first inner folded ring 211 protrudes upward. That is, the first inner folded ring 211 makes it possible to increase the volume of the first auxiliary magnet 114 without changing the thickness of the sound generating apparatus 100, so that the performance of the sound generating apparatus 100 is improved. The effect produced by providing the second inner folded ring 311 on the second annular diaphragm 31 is similar, and details are not repeated here.

Referring to FIG. 3 to FIG. 5, in an embodiment, the central magnetic circuit includes a central magnet 111, a secondary central magnet 112, and a first auxiliary magnet 114. The secondary central magnet 112 surrounds an outer periphery of the central magnet 111 and is spaced apart from the central magnet 111 to form the second magnetic gap 117. The side magnet 113 surrounds an outer periphery of the secondary central magnet 112 and is spaced apart from the secondary central magnet 112 to form the first magnetic gap 116. The first auxiliary magnet 114 is provided on a side of the central magnet 111 facing the first annular diaphragm 21, and the inner peripheral edge of the side of the first annular diaphragm 21 facing the second vibration system 3 is connected to the first auxiliary magnet 114. In this embodiment, adding the first auxiliary magnet 114 increases the number of magnets in the magnetic circuit system 1 of the sound generating apparatus 100, thereby helping improve performance of the sound generating apparatus 100. In addition, taking the first annular diaphragm 21 as an example, the inner peripheral edge of the first annular diaphragm 21 abuts against the first auxiliary magnet 114, which helps improve stability of the first annular diaphragm 21.

In an embodiment, the second diaphragm 31A includes a second annular diaphragm 31, and the central magnetic circuit further includes a second auxiliary magnet 115. The first auxiliary magnet 114 and the second auxiliary magnet 115 are provided opposite to each other on two sides of the central magnet 111 along a vertical direction. A magnetization direction of the first auxiliary magnet 114 is opposite to a magnetization direction of the second auxiliary magnet 115. The inner peripheral edge of the side of the second annular diaphragm 31 facing the first annular diaphragm 21 is connected to the second auxiliary magnet 115. In this embodiment, adding the second auxiliary magnet 115 increases the number of magnets in the magnetic circuit system 1 of the sound generating apparatus 100, thereby helping improve performance of the sound generating apparatus 100. In addition, the inner peripheral edge of the second annular diaphragm 31 abuts against the second auxiliary magnet 115, which helps improve stability of the second annular diaphragm 31. It should be noted that the size of a portion of the first auxiliary magnet 114 protruding from the inner ring of the first annular diaphragm 21 is adapted to the size of the inner ring of the first annular diaphragm 21. Similarly, the size of a portion of the second auxiliary magnet 115 protruding from the inner ring of the second annular diaphragm 31 is adapted to the size of the inner ring of the second annular diaphragm 31. It should be noted that, by adding the second auxiliary magnet 115, the sound generating apparatus 100 has better performance at the same volume and has a smaller volume at the same performance compared with a conventional double-sided sound generating apparatus.

According to an embodiment of the present application, the first annular diaphragm 21 and the second annular diaphragm 31 are different in both size and shape, and the first dome 23 and the second dome 33 are different in both size and shape. The first annular diaphragm 21 and the second annular diaphragm 31 are different in both size and shape because, on one hand, the first annular diaphragm 21 can be adapted to the size of the first auxiliary magnet 114 and the second annular diaphragm 31 can be adapted to the size of the second auxiliary magnet 115, so that space is effectively used, and on the other hand, an effective vibration area of the first annular diaphragm 21 can be equal to an effective vibration area of the second annular diaphragm 31. It should be noted that the effective vibration area refers to an effective vibration area of a diaphragm during vibration of the sound generating apparatus 100.

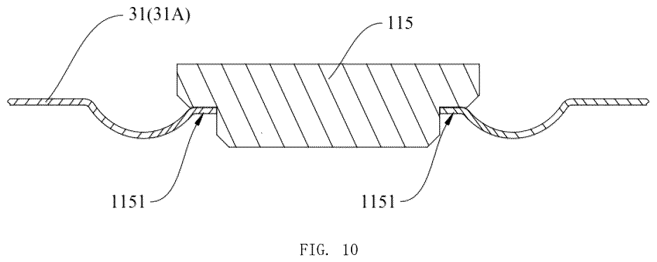

Referring to FIG. 10, in an embodiment, an outer edge of the second auxiliary magnet 115 is provided with a second mounting groove, and the inner peripheral edge of the side of the second annular diaphragm 31 facing the first annular diaphragm 21 is connected to a bottom wall of the second mounting groove. By providing the second mounting groove, a portion of the second auxiliary magnet 115 can protrude through an inner ring of the second annular diaphragm 31, thereby effectively increasing the volume of the second auxiliary magnet 115 and improving performance of the sound generating apparatus 100. In addition, providing the second mounting groove can provide clearance for the vibration space of the second annular diaphragm 31 and reduce the probability of interference between the second annular diaphragm 31 and the second auxiliary magnet 115.

According to an embodiment of the present application, the inner peripheral edge of the side of the second annular diaphragm 31 facing the first annular diaphragm 21 is connected to the bottom surface of the magnetic circuit system 1. The bottom surface of the magnetic circuit system 1 is located above the second annular diaphragm 31, that is, the bottom surface of the magnetic circuit system 1 does not extend out from the inner ring of the second annular diaphragm 31. In this way, the opening in the inner ring of the second annular diaphragm 31 need not be excessively large, thereby ensuring strength of the second annular diaphragm 31.

In an embodiment, the secondary central magnet 112 includes an annular secondary central magnet, and/or the side magnet 113 includes an annular side magnet. The annular secondary central magnet has a larger volume than two spaced strip magnets, and therefore can improve performance of the sound generating apparatus 100. The annular side magnet can also further improve performance of the sound generating apparatus 100 compared with two strip magnets.

According to an embodiment of the present application, the secondary central magnet 112 and the side magnet 113 may be folded-edge magnets or two strip magnets, which have a lower cost than annular magnets.

Referring to FIG. 3 to FIG. 5, in an embodiment, the magnetic circuit system 1 further includes a magnetic conductive plate assembly 12. The magnetic conductive plate assembly 12 includes a first magnetic conductive plate 121 and a second magnetic conductive plate 122. Sides of the central magnet 111 and the secondary central magnet 112 distant from the first annular diaphragm 21 are both connected to the first magnetic conductive plate 121, and another side of the first magnetic conductive plate 121 is connected to the first auxiliary magnet 114. Sides of the secondary central magnet 112 and the side magnet 113 facing the first annular diaphragm 21 are both connected to the second magnetic conductive plate 122. By providing the first magnetic conductive plate 121 to connect the central magnet 111 and the secondary central magnet 112, magnetic conduction through the first magnetic conductive plate 121 ensures magnetic flux of the second magnetic gap 117, so that sound emitted by the sound generating apparatus 100 is more accurate. Similarly, by providing the second magnetic conductive plate 122 to connect the secondary central magnet 112 and the side magnet 113, magnetic conduction through the second magnetic conductive plate 122 ensures magnetic flux of the first magnetic gap 116, so that sound emitted by the sound generating apparatus 100 is more accurate.

In an embodiment, the magnetic conductive plate assembly 12 further includes a third magnetic conductive plate 123 and a side magnetic conductive plate 124. The third magnetic conductive plate 123 is sandwiched between the second auxiliary magnet 115 and the central magnet 111. The side magnet 113 is connected to the side magnetic conductive plate 124 on a side adjacent to the first annular diaphragm 21. By providing the third magnetic conductive plate 123 between the central magnet 111 and the second auxiliary magnet 115, the second auxiliary magnet 115 and the central magnet 111 can conduct magnetism through the third magnetic conductive plate 123 to ensure magnetic flux of the second magnetic gap 117. By connecting the side magnetic conductive plate 124 to the side magnet 113, the side magnet 113 can conduct magnetism through the side magnetic conductive plate 124 to ensure magnetic flux of the first magnetic gap 116. In an embodiment, the sound generating apparatus 100 further includes a first annular mounting bracket 41. The first annular mounting bracket 41 is connected to a side of the side magnetic conductive plate 124 facing the first annular diaphragm 21, and an outer edge of the first annular diaphragm 21 is connected to the first annular mounting bracket 41. Alternatively, the side magnetic conductive plate 124 protrudes in a direction facing the first annular diaphragm 21 to form a first fixing portion, and the outer edge of the first annular diaphragm 21 is connected to the first fixing portion. Alternatively, the sound generating apparatus 100 further includes a first annular mounting bracket 41, and the side magnetic conductive plate 124 includes a flat plate portion and a bent portion connected to each other. The side magnet 113 is connected to the flat plate portion adjacent to the first annular diaphragm 21, the bent portion is provided on a side of the flat plate portion adjacent to the first annular diaphragm 21 and forms an annular support together with the first annular mounting bracket 41, and the outer edge of the first annular diaphragm 21 is connected to the annular support. The outer edge of the first annular diaphragm 21 is fixed by the first annular mounting bracket 41, thereby improving stability of the first annular diaphragm 21. Alternatively, the side magnetic conductive plate 124 protrudes upward to form the first fixing portion, the first fixing portion is an annular fixing portion, and the outer edge of the first annular diaphragm 21 is connected to the first fixing portion, improving stability of the first annular diaphragm 21. Alternatively, the side magnetic conductive plate 124 is provided with the bent portion, the bent portion and the first annular mounting bracket 41 together define the annular support, and the outer edge of the first annular diaphragm 21 is connected to the annular support, improving stability of the first annular diaphragm 21.

According to an embodiment of the present application, the outer edge of the first annular diaphragm 21 is connected to the annular support, thereby improving stability of the first annular diaphragm 21.

According to another embodiment of the present application, the outer edge of the first annular diaphragm 21 is connected to the bent portion, thereby improving stability of the first annular diaphragm 21.

In an embodiment, an outer edge of the side magnet 113 protrudes in a direction distant from the first annular diaphragm 21 to form a second fixing portion, and an outer edge of the diaphragm of the second vibration system 3 is connected to the second fixing portion. Alternatively, the second magnetic conductive plate 122 protrudes in a direction distant from the first annular diaphragm 21 to form a third fixing portion, and the third fixing portion is connected to the outer edge of the diaphragm of the second vibration system 3. Alternatively, the outer edge of the side magnet 113 protrudes in a direction distant from the first annular diaphragm 21 to form a fourth fixing portion 1131, the sound generating apparatus 100 further includes a second annular mounting bracket 42, the second annular mounting bracket 42 is provided on an inner peripheral side of the fourth fixing portion 1131, and an outer edge of the second diaphragm 31A is connected to the second annular mounting bracket 42. The outer edge of the side magnet 113 protrudes downward to form the second fixing portion, and the second fixing portion can not only fix an outer edge of the second annular diaphragm 31, but also increase the volume of the side magnet 113 due to the downward protrusion of the side magnet 113, thereby improving performance of the sound generating apparatus 100. Alternatively, the second magnetic conductive plate 122 protrudes downward to form the third fixing portion, and the third fixing portion is connected to the outer edge of the second annular diaphragm 31, thereby improving stability of the second annular diaphragm 31. Alternatively, the side magnet 113 protrudes downward to form the fourth fixing portion 1131, and the second annular mounting bracket 42 is provided inside the fourth fixing portion 1131. The fourth fixing portion 1131 can not only limit the second annular mounting bracket 42, but more importantly can effectively improve performance of the sound generating apparatus 100. The second annular mounting bracket 42 is connected to the outer edge of the second annular diaphragm 31, thereby improving stability of the second annular diaphragm 31.

It should be noted that the first annular mounting bracket 41 and the second annular mounting bracket 42 are both plastic frames, which avoid a risk of short circuit caused by conductivity of the frames themselves compared with metal frames.

In an embodiment, a dimension of the second auxiliary magnet 115 in a horizontal plane along at least one of a first direction and a second direction is less than a dimension of the central magnet 111 in a corresponding direction. The first direction may be a width direction of the sound generating apparatus 100, and the second direction may be a length direction of the sound generating apparatus 100. The dimension of the second auxiliary magnet 115 in at least one of the first direction and the second direction is less than the dimension of the central magnet 111, mainly to provide clearance for the vibration space of the first annular diaphragm 21. It should be noted that the first direction is the left-right direction shown in FIG. 1, and the second direction is the front-rear direction shown in FIG. 1.

In an embodiment, a dimension of the first auxiliary magnet 114 extending in a horizontal plane along the first direction is greater than a dimension of the central magnet 111 extending along the first direction, and a dimension of the first auxiliary magnet 114 extending in the horizontal plane along the second direction is greater than a dimension of the central magnet 111 extending along the second direction. The dimensions of the first auxiliary magnet 114 in both the first direction and the second direction are greater than the dimensions of the central magnet 111 so that the first auxiliary magnet 114 can act on both the first magnetic gap 116 and the second magnetic gap 117, thereby effectively improving performance of the sound generating apparatus 100.

In an embodiment, the first auxiliary magnet 114 is provided with a first clearance portion, and/or the second auxiliary magnet 115 is provided with a second clearance portion. The first clearance portion is provided on the first auxiliary magnet 114 to provide clearance for the vibration space of the first annular diaphragm 21, and the second clearance portion is provided on the second auxiliary magnet 115 to provide clearance for the vibration space of the second annular diaphragm 31. It should be noted that the first clearance portion and the second clearance portion may be chamfers or clearance grooves.

Referring to FIG. 3, in an embodiment, the sound generating apparatus 100 further includes an isolation member 5. The isolation member 5 is provided with a plurality of vent holes 51. The isolation member 5 surrounds an outer periphery of the side magnet 113 and is connected to the side magnet 113. By arranging the isolation member 5 around the outer periphery of the side magnet 113, sound-absorbing particles are isolated from the sound generating apparatus, preventing the sound-absorbing particles from entering the sound generating apparatus and affecting sound quality of the sound generating apparatus. It should be noted that, because a pore diameter of the vent holes 51 is less than a particle diameter of the sound-absorbing particles, the isolation member 5 can ensure gas circulation while preventing the sound-absorbing particles from passing through the isolation member 5 and entering the interior of the sound generating apparatus.

In an embodiment, the first annular diaphragm 21 is provided with a first conductive layer 213, the sound generating apparatus 100 includes a first annular mounting bracket 41, and solder pads are injection-molded in the first annular mounting bracket 41. The first conductive layer 213 is electrically connected to the first voice coil 22 and the solder pads. And/or, the second diaphragm 31A is provided with a second conductive layer 313, the sound generating apparatus 100 includes a second annular mounting bracket 42, and solder pads are injection-molded in the second annular mounting bracket 42. The second conductive layer 313 is electrically connected to the second voice coil 32 and the solder pads. Taking the first conductive layer 213 as an example, by using the first conductive layer 213 to electrically connect with the solder pads, compared with a conventional diaphragm, the first conductive layer 213 in this embodiment can omit a conductive support plate, thereby saving internal space. The saved space can be used to fill more magnets and improve performance of the sound generating apparatus 100. The effect of using the second conductive layer 313 is similar to the effect of using the first conductive layer 213, and details are not repeated here.

In an embodiment, the first annular diaphragm 21 and the diaphragm of the second vibration system 3 have the same effective vibration area. The first annular diaphragm 21 and the second annular diaphragm 31 having the same effective vibration area can further reduce leakage and improve call privacy when the sound generating apparatus 100 is applied to an electronic device requiring call privacy. It should be noted that the first vibration system and the second vibration system have the same or similar TS parameters and performance.

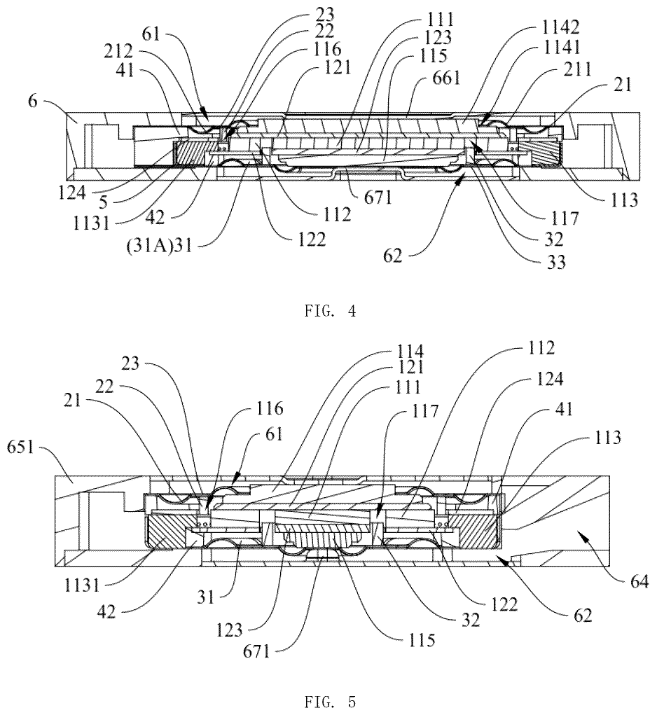

Referring to FIG. 4 and FIG. 5, in an embodiment, the first magnetic gap 116 and the second magnetic gap 117 are spaced apart in a horizontal direction. Because the first magnetic gap 116 and the second magnetic gap 117 are spaced apart in the horizontal direction, compared with an existing sound generating apparatus 100 provided with two magnetic gaps spaced apart in a vertical direction, the sound generating apparatus 100 in this embodiment can be made thinner, that is, a dimension in an up-down direction can be reduced, thereby better adapting to use scenarios with limited installation space and facilitating miniaturization and thickness reduction of the sound generating apparatus 100. It should be noted that the first magnetic gap 116 and the second magnetic gap 117 being spaced apart in the horizontal direction means that the second magnetic gap 117 is located on an inner ring side of the first magnetic gap 116. It should also be noted that the up-down direction is the up-down direction shown in the figures.

The present application further provides an electronic device. The electronic device includes a device housing and the sound generating apparatus 100 described above. Specifically, the electronic device may be a wearable electronic device, such as a watch. In addition, the electronic device may also be earphones, a mobile phone, a wristband, a laptop computer, a virtual reality (VR) device, an augmented reality (AR) device, or the like. Because the electronic device adopts all the technical solutions of all the embodiments described above, the electronic device has at least all beneficial effects brought about by the technical solutions of the embodiments described above, and details are not repeated here.

The above descriptions are merely exemplary embodiments of the present application and do not limit the patent scope of the present application. Any equivalent structural transformation made based on the description and drawings of the present application under the inventive concept of the present application, or any direct or indirect application to other related technical fields, falls within the patent protection scope of the present application.

What is claimed is:

1. A sound generating apparatus, comprising:
a magnetic circuit system comprising a magnet assembly, wherein the magnet assembly comprises a central magnetic circuit and a side magnet surrounding the central magnetic circuit, the central magnetic circuit and the side magnet form a first magnetic gap, and the central magnetic circuit forms a second magnetic gap;
a first vibration system, wherein the first vibration system comprises a first annular diaphragm and a first voice coil connected to each other, and the first voice coil corresponds to the first magnetic gap;
a second vibration system, wherein the second vibration system comprises a second diaphragm and a second voice coil connected to each other, the second voice coil corresponds to the second magnetic gap, and the first vibration system and the second vibration system are respectively provided on two sides of the magnetic circuit system along a vibration direction; and
a housing configured to accommodate the magnetic circuit system, the first vibration system, and the second vibration system, wherein a height of the first annular diaphragm is not greater than a height of a top surface of the magnetic circuit system, such that the housing and the first vibration system enclose a first acoustic cavity, a side wall of the housing is provided with a first side acoustic hole communicating with the first acoustic cavity, the housing and the second vibration system enclose a second acoustic cavity independent of the first acoustic cavity, and the side wall of the housing is further provided with a second side acoustic hole communicating with the second acoustic cavity.

2. The sound generating apparatus according to claim 1, wherein the top surface of the central magnetic circuit is provided with a first protrusion, the first protrusion abuts against the housing, the first annular diaphragm is provided around the first protrusion, and a height of a top surface of the first annular diaphragm is not greater than a height of a top surface of the first protrusion.

3. The sound generating apparatus according to claim 2, wherein the housing comprises a housing body and a first metal sheet connected to each other, the housing body and the first metal sheet enclose an accommodating cavity configured to accommodate the magnetic circuit system, the first vibration system, and the second vibration system, the top surface of the central magnetic circuit passes through an inner hole of the first annular diaphragm and abuts against the first metal sheet, and a side wall of the housing body is provided with the first side acoustic hole and the second side acoustic hole.

4. The sound generating apparatus according to claim 1, wherein the second diaphragm comprises a second annular diaphragm;
the housing is provided with a second protrusion on a side facing the second annular diaphragm, the second protrusion abuts against a bottom surface of the central magnetic circuit, and the second annular diaphragm is provided around the second protrusion; or
the bottom surface of the central magnetic circuit is provided with a second protrusion, the second protrusion abuts against the housing, and the second annular diaphragm is provided around the second protrusion.

5. The sound generating apparatus according to claim 4, wherein the housing comprises a housing body and a second metal sheet connected to each other, the second metal sheet protrudes on a side facing the second annular diaphragm to form the second protrusion, the second protrusion passes through an inner hole of the second annular diaphragm and abuts against the bottom surface of the central magnetic circuit, and a side wall of the housing is provided with the first side acoustic hole and the second side acoustic hole.

6. The sound generating apparatus according to claim 1, wherein an outer edge of the top surface of the magnetic circuit system is provided with a first mounting groove, and an inner peripheral edge of a side of the first annular diaphragm facing the second vibration system is connected to a bottom wall of the first mounting groove.

7. The sound generating apparatus according to claim 1, wherein the sound generating apparatus comprises a first working state and a second working state, in the first working state, the first vibration system and the second vibration system radiate sound waves of a same phase outward, and in the second working state, the first vibration system and the second vibration system radiate sound waves of opposite phases outward.

8. The sound generating apparatus according to claim 1, wherein the first annular diaphragm is sequentially provided with a first inner folded ring and a first outer folded ring from inside to outside, the first vibration system comprises a first dome, the first dome is connected to the first annular diaphragm and is located between the first inner folded ring and the first outer folded ring, and the first voice coil is fixed to the first dome; and
the second diaphragm is sequentially provided with a second inner folded ring and a second outer folded ring from inside to outside, the second vibration system comprises a second dome, the second dome is connected to the second diaphragm and is located between the second inner folded ring and the second outer folded ring, and the second voice coil is fixed to the second dome.

9. The sound generating apparatus according to claim 8, wherein the first inner folded ring protrudes in a direction distant from the second diaphragm, the first outer folded ring protrudes in a direction toward the second diaphragm, the second inner folded ring protrudes in a direction distant from the first annular diaphragm, and the second outer folded ring protrudes in a direction toward the first annular diaphragm.

10. The sound generating apparatus according to claim 1, wherein the central magnetic circuit comprises a central magnet, a secondary central magnet, and a first auxiliary magnet, the secondary central magnet surrounds an outer periphery of the central magnet and is spaced apart from the central magnet to form the second magnetic gap, the side magnet surrounds an outer periphery of the secondary central magnet and is spaced apart from the secondary central magnet to form the first magnetic gap, and an inner peripheral edge of a side of the first annular diaphragm facing the second diaphragm is connected to the first auxiliary magnet.

11. The sound generating apparatus according to claim 10, wherein the second diaphragm comprises a second annular diaphragm, the central magnetic circuit further comprises a second auxiliary magnet, the first auxiliary magnet and the second auxiliary magnet are provided opposite to each other on two sides of the central magnet along a vertical direction, a magnetization direction of the first auxiliary magnet is opposite to a magnetization direction of the second auxiliary magnet, and an inner peripheral edge of a side of the second annular diaphragm facing the first annular diaphragm is connected to the second auxiliary magnet.

12. The sound generating apparatus according to claim 11, wherein the magnetic circuit system further comprises a magnetic conductive plate assembly, the magnetic conductive plate assembly comprises a first magnetic conductive plate and a second magnetic conductive plate, sides of the central magnet and the secondary central magnet distant from the first annular diaphragm are connected to the first magnetic conductive plate, another side of the first magnetic conductive plate is connected to the first auxiliary magnet, and sides of the secondary central magnet and the side magnet facing the first annular diaphragm are connected to the second magnetic conductive plate.

13. The sound generating apparatus according to claim 12, wherein the magnetic conductive plate assembly further comprises a third magnetic conductive plate and a side magnetic conductive plate, the third magnetic conductive plate is sandwiched between the second auxiliary magnet and the central magnet, and the side magnet is connected to the side magnetic conductive plate on a side adjacent to the first annular diaphragm.

14. The sound generating apparatus according to claim 10, wherein a dimension of the second auxiliary magnet in a horizontal plane along at least one of a first direction and a second direction is less than a dimension of the central magnet in a corresponding direction.

15. The sound generating apparatus according to claim 11, wherein a dimension of the first auxiliary magnet extending in a horizontal plane along the first direction is greater than a dimension of the central magnet extending along the first direction, and a dimension of the first auxiliary magnet extending in the horizontal plane along the second direction is greater than a dimension of the central magnet extending along the second direction.

16. The sound generating apparatus according to claim 10, further comprising:
an isolation member provided with a plurality of vent holes, wherein the isolation member surrounds an outer periphery of the side magnet and is connected to the side magnet.

17. The sound generating apparatus according to claim 1, wherein:
the first annular diaphragm is provided with a first conductive layer, and the first conductive layer is electrically connected to the first voice coil and a solder pad.

18. The sound generating apparatus according to claim 1, wherein:
the second diaphragm is provided with a second conductive layer, and the second conductive layer is electrically connected to the second voice coil and a solder pad.

19. The sound generating apparatus according to claim 1, wherein the first magnetic gap and the second magnetic gap are spaced apart in a horizontal direction.

20. An electronic device, comprising a device housing and the sound generating apparatus according to claim 1.
